(19) United States
(12) Patent Application Publication
(10) Pub. No.: US 2023/0296386 A1
(43) Pub. Date: Sep. 21, 2023

(54) Indoor Voice Navigation System, Indoor Voice Navigation Method and Non-Transitory Computer Readable Medium Thereof

(71) Applicants: Charles C. N. Wang, Kaohsiung City (TW); Wen-Lian Hsu, Taipei City (TW); Asia University, Taichung CIty (TW)

(72) Inventors: Charles C. N. Wang, Kaohsiung City (TW); Wen-Lian Hsu, Taipei City (TW)

(21) Appl. No.: 18/183,753

(22) Filed: Mar. 14, 2023

(30) Foreign Application Priority Data
Mar. 15, 2022 (TW) 111109381

(51) Int. Cl. G01C 21/20; G06K 7/14

(52) U.S. Cl. CPC G01C 21/206; G06K 7/1417

(57) ABSTRACT

An indoor voice navigation system and indoor voice navigation method are provided. An initial position and a target position is inputted to the indoor voice navigation system to generate an actual navigation path from the initial position to the target position, where the actual navigation path comprises at least one positioning location and each positioning location contains a two-dimensional barcode to describe its location information. The indoor voice navigation system is able to find a next positioning location in the actual navigation path and set the next positioning location as a new initial position repeatedly. And, in the way of finding the next positioning location, the indoor voice navigation system may suggest a direction and a distance by voice. With above technical features, the system and method may achieve the goal of navigating in the interior environment by lower cost.

### CROSS-REFERENCE TO RELATED APPLICATION

This application claims the benefit of Taiwan Patent Application No. 111109381, filed on Mar. 15, 2022, in the Taiwan Intellectual Property Office, the disclosure of which is incorporated herein in its entirety by reference.

### BACKGROUND OF THE INVENTION

### 1. Field of the Invention

The present invention relates to an indoor voice navigation system and an indoor voice navigation method, and more particularly, to an indoor navigation system for combining voice and map data recognition functions and an indoor navigation method thereof.

### 2. Description of the Related Art

The conventional navigation system performs a positioning by using a global positioning system (GPS). The GPS is composed of a space segment, a global control segment and a user equipment segment, in which the triangulation is used to calculate a distance that the user equipment segment travels on the ground surface. However, the algorithm limits the GPS to outdoor use only. When the user equipment segment enters indoor, GPS may not work.

There are sufficient demands for indoor navigation in application to actual living. For example, in order to find a booth at a specific point in a wide area of exhibition center, find a specific type of product in a large supermarket, find a teacher's research office in a school, or find a parking location in a multi-story parking lot, a searcher usually arrives at the destination by recognizing road signs in the above places. However, according to the above-described scheme, various road signs are required to be established in indoor places, and the seeker may also spend a lot of time while fumbling to the destination, thereby causing much inconvenience to both merchants and searchers.

In conclusion, the inventor of the present invention has considered and designed an indoor voice navigation system and an indoor voice navigation method, to improve the deficiencies in the related art, and increased the industrial applicability.

### SUMMARY OF THE INVENTION

For the above purposes, the present invention provides an indoor voice navigation system applied to a mobile device for performing navigation in an indoor environment, and including a processor and a non-transitory data storage, the non-transitory data storage storing a computer code of a map data storage module, a computer code of a route navigation module, a computer code of a route calculation module, a computer code of a voice guidance module, a computer code of an image capture and analysis module, a computer code of a route rearrangement module and a computer code of a route display module. The map data storage module includes a two-dimensional plan map corresponding to the indoor environment. The route navigation module is used to input an initial location and a target location in the indoor environment to calculate an actual navigation route from the initial location to the destination location, so that a predetermined map data navigation route corresponding to the route from the initial location to the target location is calculated on the two-dimensional plan map. The actual navigation route includes at least one positioning location, and each of the at least one positioning location has a two-dimensional barcode. The route calculation module searches for one of the at least one positioning location closest to the mobile device in the map data navigation route, and automatically sets the closest one as a candidate location. In addition, the route calculation module dynamically calculates a distance and a traveling direction between the mobile device and the candidate location. The voice guidance module guides the distance and the traveling direction by using voice. The image capture and analysis module is used to capture the two-dimensional barcode of the candidate location and read location information of the candidate location. After the mobile device arrives at the candidate location and reads the location information of the candidate location, the route rearrangement module sets the candidate location as the initial location and inputs the initial location to the route navigation module, so that the route navigation module recalculates the actual navigation route and the map data navigation route from the candidate location to the target location. The route display module is used to update and display the two-dimensional plan map and the map data navigation route.

Preferably, the voice guidance module may further include guiding a place to pass through on the actual navigation route or enabling a user to voice input the target location or an identifiable sign.

Preferably, the at least one positioning location includes any one of an intersection, a curved road, an elevator entrance, or a stairway.

Preferably, the two-dimensional barcode includes a QR code.

Preferably, the distance includes a horizontal distance and a vertical distance.

For the above purposes, the present invention further provides an indoor voice navigation method applied to a mobile device installed with an indoor voice navigation system. The indoor voice navigation method includes the following steps:

A two-dimensional plan map corresponding to an indoor environment is stored.

An initial location and a target location in the indoor environment are input to calculate an actual navigation route from the initial location to the destination location, and a predetermined map data navigation route corresponding to the initial location to the target location is output on the two-dimensional plan map.

One of the at least one positioning location closest to the mobile device is searched on the map data navigation route, and the closest one is automatically set as a candidate location.

A distance and a traveling direction between the mobile device and a candidate location are dynamically calculated, and the distance and the traveling direction are notified by voice.

When the mobile device reaches the candidate location, the two-dimensional barcode of the candidate location is captured to read location information of the candidate location.

The candidate location is set as an initial location and the actual navigation route and the map data navigation route from the candidate location to the target location are recalculated.

The two-dimensional plan map and the map data navigation route are updated and displayed.

Preferably, the indoor voice navigation method of the present invention further includes guiding a place to pass through in the actual navigation route or allowing a user to voice input the target location or an identifiable sign.

Preferably, the at least one positioning location includes any one of an intersection, a curved road, an elevator entrance, or a stairway.

Preferably, the two-dimensional barcode includes a QR code.

Preferably, the distance includes a horizontal distance and a vertical distance.

As can be seen from the above description, the indoor voice navigation system and the indoor voice navigation method disclosed according to the present invention have the following technical effects: (1) the destination the user wants to go can be obtained through conversation with the user, so that the user can be guided to the destination by voice. (2) Further, according to the present invention a single-story place (such as shopping mall or exhibition hall) may be converted into a computer two-dimensional plan map, in which the computer two-dimensional plan map may be composed of a walking passage and a plurality of positioning locations. When the user searches for the place through the present invention, the user may receive appropriate voice feedback on every walking through positioning locations, so that the user can recognize a distance or a direction to the next positioning location, and reach exactly where the user wants to go. (3) Further, the present invention can be combined with an existing outdoor navigation system, such as Google Map. When the user wants to move from outdoors to a location inside a building, the present invention can guide the user to the building using the outdoor navigation system first. After arrival, it is switched to the indoor voice navigation system disclosed according to the present invention, so that the user can be smoothly guided from outdoors to indoor destinations.

### BRIEF DESCRIPTION OF THE DRAWINGS

FIG. 1 is a configuration diagram of an indoor voice navigation system according to the present invention.

FIG. 2a is a first schematic diagram of the indoor voice navigation system according to the present invention.

FIG. 2b is a second schematic diagram of the indoor voice navigation system according to the present invention.

FIG. 2c is a third schematic diagram of the indoor voice navigation system according to the present invention.

FIG. 3 is a flowchart of an indoor voice navigation method according to the present invention.

FIG. 4 is a block diagram illustrating a machine able to read computer codes from a computer-readable medium and perform any of the methodologies discussed herein, according to an example embodiment.

### DETAILED DESCRIPTION OF THE INVENTION

In order to understand the features, contents and advantages of the present invention and the effects implemented thereby, hereinafter, the present invention will be described using representative expressions of the embodiments in detail with reference to the drawings as follows. However, the drawings are only intended to supplement the specification as a gist, and may not correspond to the actual proportions and exact arrangements after implementation of the present invention. Therefore, the drawings do not limit the scope of the claims to be actually implemented by the present invention upon interpretation related to the configuration and arrangement of the accompanying drawings.

Advantages, features and technical solutions to be achieved according to the present invention will be more easily understood by describing in more detail the accompanying drawings and the embodiments as reference examples. Further, the present invention may be implemented in various forms and will not be construed as being limited only to the embodiments described herein. Whereas, for those having ordinary skill in the art, the embodiments will be provided with a more thorough understanding of the disclosure of the present invention and the scope of the present invention will be fully delivered. Further, the present invention will be subject to the following claims.

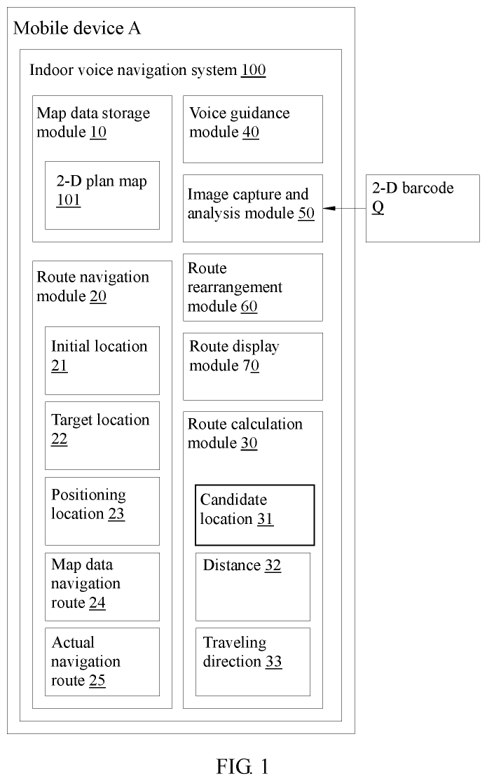

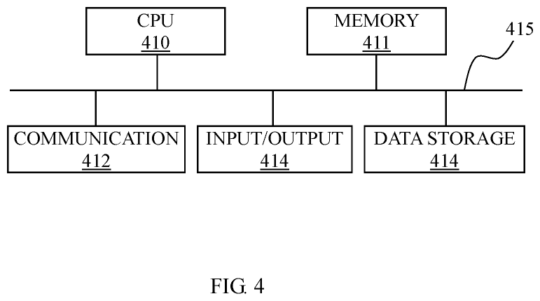

FIG. 1 is a configuration diagram of an indoor voice navigation system according to the present invention. As shown in the drawings, the indoor voice navigation system 100 of the present invention is applied to a mobile device A for performing navigation in an indoor environment R. The mobile device may be a smartphone or a tablet computer. The indoor voice navigation system 100 may include one or more processors, for example, the CPU 410 illustrated in FIG. 4. The indoor voice navigation system 100 may further include one or more data storage, for example, the memory 411 or data storage 414 illustrated in FIG. 4. The data storage may store computer codes of software modules, which may include a map data storage module 10, a route navigation module 20, a route calculation module 30, a voice guidance module 40, an image capture and analysis module 50, a route rearrangement module 60 and a route display module 70, as depicted in FIG. 1. The voice guidance module 40 may be able to manipulate a speaker, the image capture and analysis module 50 may be an image analysis program configured to analyze images acquired by a camera lens, the route display module 70 may be used to display map data information on a display screen of the mobile device A, and the remaining modules may be predefined software applications on the mobile device A or may be called subroutines. Hereinafter, the technical features of the modules will be described as follows.

The map data storage module 10 may be a compact data storage system, for example, the memory 411 or data storage 414 illustrated in FIG. 4, and a two-dimensional plan map 11 corresponding to the indoor environment R may be stored therein, in which the two-dimensional plan map 11 may be stored in advance or input by a user. The route navigation module 20 may be used to enable a searcher to input an initial location 21 and a target location 22 in the indoor environment R. The route navigation module 20 may attempt to find an actual navigation route 25 from the initial location 21 to the target location 22. A map data navigation route 24 corresponding to a route from the initial location 21 to the target location 22 on the two-dimensional plan map 11 is calculated by the map data storage module 10. The map data navigation route 24 may correspond to the actual navigation route 25 of the indoor environment R. In addition, the actual navigation route 25 may include at least one positioning location 23. In addition, a two-dimensional barcode Q is provided at each positioning location 23, in which the two-dimensional barcode Q may be a QR code, and information embedded therein may correspond to the actual geographic information of the positioning location 23, such as classroom names, meeting room numbers, parking lot entrances, and exhibition booth numbers.

Particularly, when the positioning location 23 is first set, a preferred determination is based on whether the searcher needs to make a judgmental decision about route selection, for example, at intersections or curved roads with multiple lines, or an elevator entrance or a stairway through which the searcher may advance upward or downward. In addition, separate two-dimensional barcodes Q may be attached to walls of the above places or to easily identified places, and the two-dimensional barcodes Q may be read, so that the indoor voice navigation system 100 of the present invention may accurately know where the searcher's actual location is indoors currently.

In addition, after the map data navigation route 24 is established, the route calculation module 30 may find the positioning location 23 closest to the mobile device A (that is, the searcher) on the map data navigation route 24, and automatically set the closest position location as a candidate location 31. The route calculation module 30 may additionally and dynamically calculate a distance 32 and a traveling direction 33 between the mobile device A and the candidate location 31, and the voice guidance module 40 may remind the searcher of the distance 32 from the candidate location 31 and the traveling direction 33 by voice.

In addition, when the searcher arrives at the candidate location 31 according to the guidance based on the distance 32 and the traveling direction 33, the searcher may capture a two-dimensional barcode Q of the candidate location 31 by using the image capture and analysis module 50 on the mobile device A, so that location information of the candidate location 31 may be read.

Thereafter, the route rearrangement module 60 may regard the candidate location 31 as an initial location 21, and input the initial location 21 to the route navigation module 20, so that the route navigation module 20 recalculates an actual navigation route 25 and a map data navigation route 24 from the candidate location 31 to the target location 22. The map data navigation route 24 of the latest two-dimensional plan map 11 may be updated again by the route display module 70, and displayed on the display screen of the mobile device A.

In other simple words, when the searcher is required to make a decision during the navigation route indoors, the searcher is reminded by voice for the distance and the traveling direction to the next positioning location through the positioning location defined according to the present invention and the two-dimensional barcode displayed thereby, and recursively moves forward on the navigation route until reaching the destination.

Particularly, the indoor voice navigation system 100 of the present invention may provide guidance in a horizontal direction (e.g., turning at an intersection) to the searcher, and may provide guidance in a vertical direction (e.g., walking up the stairs to the third floor). The directional guidance may be provided within a three-dimensional space in the above manner, so that the navigation effect can be implemented more accurately in the indoor environment.

In addition, in the preferred embodiment, the voice guidance module 40 of the indoor voice navigation system 100 according to the present invention further includes indicating places to pass through on the actual navigation route 25, to provide additional information to the searcher with regards to the navigation route. In addition, the voice guidance module 40 may be configured to allow the searcher to set a corresponding target location or an identifiable sign through voice input.

Particularly, the indoor voice navigation system of the present invention may also be integrated with a general outdoor navigation system such as Google Map. When the searcher is remotely located, and a target location in a building is set, the first half section may be performed by a general outdoor navigation system on the system of the present invention, so that the traveling direction and the distance may be guided. Upon arrival at the building, the guidance may be switched into the indoor voice navigation system provided by the present invention. In the above manner, whether the searcher is in the indoors or outdoors, the searcher can smoothly use the voice navigation system service provided according to the present invention.

Particularly, the switching from the outdoor navigation system to the indoor voice navigation system may be performed by clicking a building icon in the outdoor navigation system, or automatically reminding the searcher to switch via voice or text when the searcher arrives at the building. The trigger point of the switching may be determined and generated based on the arrival at the building according to the outdoor navigation system. In addition, since the software operation schemes for switching to the indoor voice navigation system are generally known to those skilled in the art of computer software programs, a detailed description will be omitted herein.

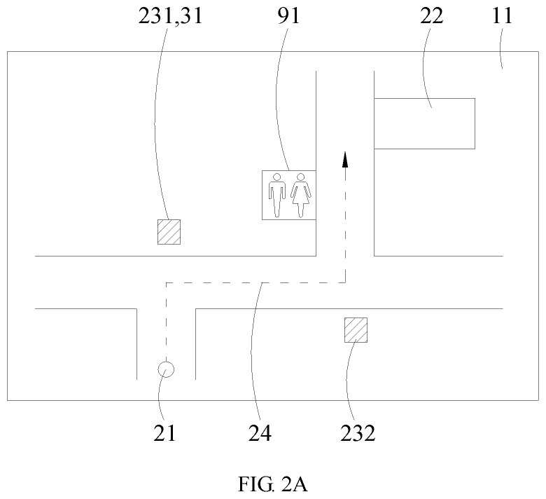

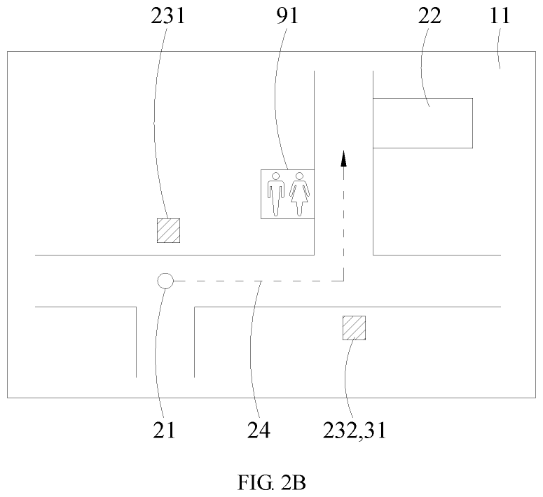

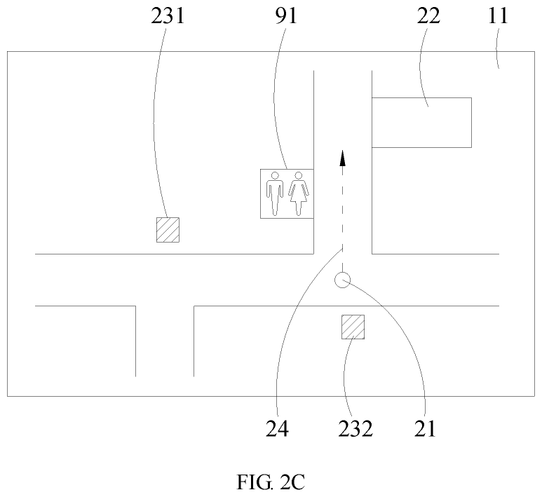

FIGS. 2a to 2c show schematic diagrams of the indoor voice navigation system of the present invention, and FIG. 1 will be referred together. FIG. 2a shows a situation in which a user uses the indoor voice navigation system 100 in a flat-story building. After the user sets a destination, the route display module 70 may display a two-dimensional plan map 11 on a screen of the mobile device. A map data navigation route 24 having an initial location 21 and a target location 22 is also included. As shown in the drawings, the user may encounter one positioning location 231 and the other positioning location 232 on the route. Since the one positioning location 231 is closer to the start position 21, the one positioning location 231 may be considered as a candidate location 31.

After reaching the positioning location 231, the user may capture a two-dimensional barcode on the positioning location 231 by using the image capture and analysis module 50, so that the route calculation module 30 may recognize current location information. Thereafter, the indoor voice navigation system 100 of the present invention may reset the positioning location 231 to an initial location 21, and additionally, the other positioning location 232 may be set as a candidate location 31. In addition, the route calculation module 30 may calculate a traveling direction 33 and a distance 32 to the candidate location 31, and the voice guidance module 40 may guide the traveling direction 33 and the distance 32 by voice. This is shown in the schematic diagram such as FIG. 2b.

In addition, after the user reaches the positioning location 232, the two-dimensional barcode on the positioning location 232 may be captured in the same step as above. At this time, there is no positioning location on the route to the arrival location 22 in the map data navigation route 24. Accordingly, the route calculation module may directly calculate the traveling direction 33 and the distance 32 to the target location 22, so that the user can directly advance and reach. Particularly, on the above route, the route calculation module 30 may provide appropriate guidance to the user according to the target location to pass through during the map data navigation route 24. In the embodiment, the route calculation module 30 may guide the user by controlling the voice guidance module 40. On the route, the user may pass through a toilet 91 first and then reach the target location 22 on the right. This is shown in a diagram such as FIG. 2c.

Particularly, when the user does not follow the suggestion of the map data navigation route 24, for example, when the user temporarily goes to a bathroom or goes to another office location, the indoor voice navigation system 100 of the present invention may provide voice guidance to the user to perform a “rearrangement” option. After confirmation by the user, a new map data navigation route 24 may be recalculated and generated, thereby ensuring that the user arrives at the intended arrival location 22 from the new location.

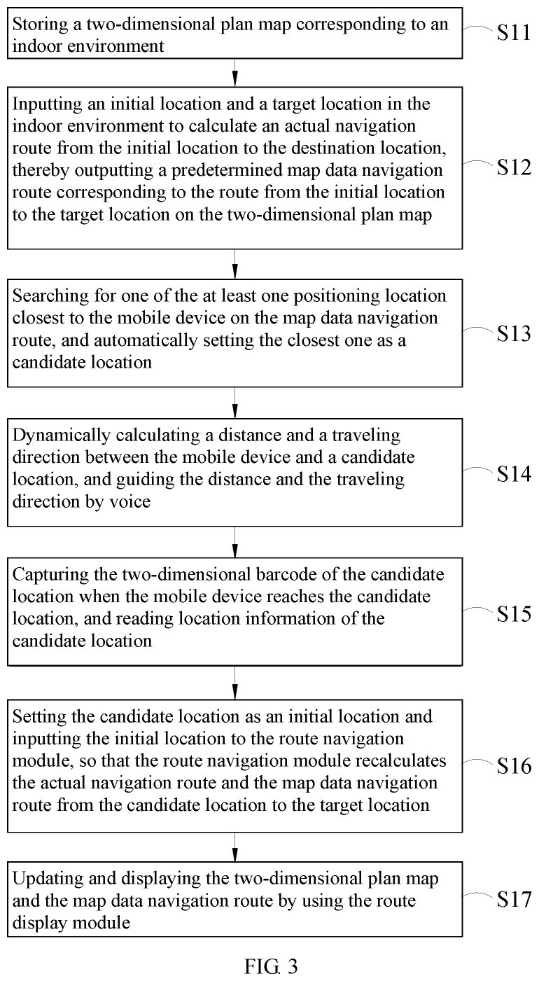

FIG. 3 is a flowchart of an indoor voice navigation method according to the present invention. As shown in the drawings, the indoor voice navigation method of the present invention applied to a mobile device installed with an indoor voice navigation system performs navigation in an indoor environment using the indoor voice navigation system. The indoor voice navigation system, as mentioned, may include a map data storage module, a route navigation module, a route calculation module, a voice guidance module, an image capture and analysis module, a route rearrangement module and a route display module. The method includes the following steps:

S11: A two-dimensional plan map corresponding to the indoor environment is stored in a map data storage module. The indoor environment may be a parking lot, store, exhibition hall, and the like. The two-dimensional plan map may include plan maps of different floors in the indoor environment.

S12: An initial location and a target location in the indoor environment are input through the route navigation module, thereby calculating a predetermined actual navigation route toward the target location, and outputting a predetermined map data navigation route corresponding to the target location from the initial location on the two-dimensional plan map. Both of the two-dimensional plan map and the map data navigation route may be displayed through the route display module, and displayed on a display screen of the mobile device.

S13: The route calculation module searches for a positioning location closest to the mobile device on the map data navigation route, and automatically sets the closest one as a candidate location. The positioning location may include any one of an intersection, a curved road, an elevator entrance, or a stairway.

S14: The route calculation module dynamically calculates a distance and a traveling direction between the mobile device and the candidate location, and the voice guidance module guides the distance and the traveling direction by voice. The distance may include a horizontal distance and a vertical distance.

S15: When the mobile device reaches the candidate location, the image capture and analysis module is used to capture the two-dimensional barcode at the candidate location, and read location information about the candidate location, in which the two-dimensional barcode may be a QR code.

S16: The route rearrangement module sets the candidate location as a new initial location and inputs the new initial location to the route guidance module, so that the route navigation module recalculates another actual navigation route and another map data navigation route from the candidate location to the target location.

S17: The route display module updates and displays the two-dimensional plan map and the map data navigation route on the display screen of the mobile device.

In the preferred embodiment, the indoor voice navigation method of the present invention further includes indicating places to pass through in the actual navigation route, or enabling the searcher to input a desired target location or an identifiable sign by voice.

As can be seen from the above description, the indoor voice navigation system and the indoor voice navigation method proposed according to the present invention can remarkably improve the defects in the related art, conduct a conversation with the searcher using voice, thereby guiding the searcher to the destination in the indoor environment, and scan the two-dimensional barcode on the positioning location to additionally guide a traveling distance, direction or floor, thereby preventing the searcher from getting lost in the indoor environment. In addition, the present invention can be combined with an existing outdoor navigation system, and accordingly, the outdoor navigation system is used first to perform navigation when the searcher is outdoors until reaching a predetermined indoor building. Thereafter, the guidance is switched to the indoor voice navigation system disclosed in the present invention, so that the searcher is smoothly guided to reach the destination indoors.

The present invention may be widely applied to navigation applications in indoor environments. For example, a student may find a classroom or professor lab, a customer may find a specific parking space number in a parking lot, a tourist may find a specific booth area in an exhibition hall, a customer may find a specific shelf or clothing store in a department store, and a warehouse staff may find a display position for a predetermined product. Therefore, compared to the conventional art, the indoor voice navigation system and the indoor voice navigation method disclosed in the present invention substantially satisfy patent requirements, such as novelty, inventive step, and industrial applicability under the Patent Act.

FIG. 4 is a block diagram illustrating components of a machine able to read instructions from a machine-readable medium and perform any of the methodologies discussed herein, according to an example embodiment.

The shown processing system 400 includes one or more processors, including a CPU 410, one or more memories 411 (at least a portion of which may be used as working memory, e.g., random access memory (RAM)), one or more data communication device(s) 412, one or more input/output (I/O) devices 413, and one or more data storage devices 414, all coupled to each other through an interconnect 415. The interconnect 415 may be or include one or more conductive traces, buses, point-to-point connections, controllers, adapters and/or other conventional connection devices. Each processor 410 controls part of the operation of the processing device 400 and can be or include, for example, one or more general-purpose programmable microprocessors, digital signal processors (DSPs), mobile application processors, microcontrollers, application specific integrated circuits (ASICs), programmable gate arrays (PGAs), or the like, or a combination of such devices.

Each memory 411 can be or include one or more physical storage devices, which may be in the form of RAM, read-only memory (ROM) (which may be erasable and programmable), flash memory, miniature hard disk drive, or other suitable type of storage device, or a combination of such devices. Each data storage device 414 can be or include one or more hard drives, digital versatile disks (DVDs), flash memories, or the like. Each memory 411 and/or data storage 414 can store (individually or collectively) data and instructions that configure the processor(s) 410 to execute operations to implement the techniques described above. Each communication device 412 may be or include, for example, an Ethernet adapter, cable modem, Wi-Fi adapter, cellular transceiver, baseband processor, Bluetooth or Bluetooth Low Energy (BLE) transceiver, or the like, or a combination thereof. Depending on the specific nature and purpose of the processing system 400, each I/O device 413 can be or include a device such as a display (which may include a transparent AR display surface), audio speaker, keyboard, mouse or other pointing device, microphone, camera, etc. Note, however, that such I/O devices may be unnecessary if the processing device 400 is embodied solely as a server computer.

In the case of a user device, a communication device 412 can be or include, for example, a cellular telecommunications transceiver (e.g., 3G, LTE/4G, 5G), Wi-Fi transceiver, baseband processor, Bluetooth or BLE transceiver, or the like, or a combination thereof. In the case of a server, a communication device 412 can be or include, for example, any of the aforementioned types of communication devices, a wired Ethernet adapter, cable modem, DSL modem, or the like, or a combination of such devices.

Unless contrary to physical possibility, it is envisioned that (i) the methods/operations described herein may be performed in any sequence and/or in any combination, and that (ii) the components of respective embodiments may be combined in any manner.

The machine-implemented operations described above can be implemented by programmable circuitry programmed/configured by software and/or firmware, or entirely by special-purpose (“hardwired”) circuitry, or by a combination of such forms. Such special-purpose circuitry (if any) can be in the form of, for example, one or more application-specific integrated circuits (ASICs), programmable logic devices (PLDs), field-programmable gate arrays (FPGAs), system-on-a-chip systems (SOCs), etc.

Software or firmware to implement the techniques introduced here may be stored on a computer-readable storage medium and may be executed by one or more general-purpose or special-purpose programmable microprocessors. A “computer-readable medium”, as the term is used herein, includes any mechanism that can tangibly store information in a non-transitory form accessible by a machine (a machine may be, for example, a computer, network device, cellular phone, personal digital assistant (PDA), manufacturing tool, any device with one or more processors, etc.). For example, a computer-readable medium includes recordable/non-recordable media (e.g., RAM or ROM; magnetic disk storage media; optical storage media; flash memory devices; etc.), etc.

The above-described embodiments have merely described the technical spirit and features of the present invention. The purpose is only for those skilled in the art to understand the content and implementation of the present invention, and the description herein is not intended to limit the scope of the present invention. Therefore, modifications and improvements according to the ideas disclosed in the present invention are still within the scope of the present invention.

What is claimed is:

1. An indoor voice navigation system applied to a mobile device for performing navigation in an indoor environment, the indoor voice navigation system comprising a processor and a non-transitory data storage, the non-transitory data storage storing:
a computer code of a map data storage module including a two-dimensional plan map corresponding to the indoor environment;
a computer code of a route navigation module configured to input an initial location and a target location in the indoor environment to calculate an actual navigation route from the initial location to the destination location, so that a predetermined map data navigation route corresponding to the route from the initial location to the target location is calculated on the two-dimensional plan map, in which the actual navigation route includes at least one positioning location, and each of the at least one positioning location has a two-dimensional barcode;
a computer code of a route calculation module configured to search for one of the at least one positioning location closest to the mobile device on the map data navigation route, and automatically set the closest one as a candidate location, and dynamically calculate a distance and a traveling direction between the mobile device and the candidate location;
a computer code of a voice guidance module configured to guide the distance between the mobile device and the candidate location and the traveling direction by voice;
a computer code of an image capture and analysis module configured to capture the two-dimensional barcode of the candidate location to read location information of the candidate location;
a computer code of a route rearrangement module configured to read the location information of the candidate location after the mobile device arrives at the candidate location, set the candidate location as the initial location and input the initial location to the route navigation module, so that the route navigation module recalculates the actual navigation route and the map data navigation route from the candidate location to the target location; and
a computer code of a route display module configured to update and display the two-dimensional plan map and the map data navigation route.

2. The indoor voice navigation system of claim 1, wherein the voice guidance module further includes guiding a place to pass through on the actual navigation route or enabling a user to voice input the target location or an identifiable sign.

3. The indoor voice navigation system of claim 1, wherein the at least one positioning location includes any one of an intersection, a curved road, an elevator entrance, or a stairway.

4. The indoor voice navigation system of claim 1, wherein the two-dimensional barcode includes a QR code.

5. The indoor voice navigation system of claim 1, wherein the distance includes a horizontal distance and a vertical distance.

6. A computer implemented indoor voice navigation method comprising:
storing a two-dimensional plan map corresponding to an indoor environment;
inputting an initial location and a target location in the indoor environment to calculate an actual navigation route from the initial location to the destination location, thereby outputting a predetermined map data navigation route corresponding to the route from the initial location to the target location on the two-dimensional plan map;
searching for one of the at least one positioning location closest to the mobile device on the map data navigation route, and automatically setting the closest one as a candidate location;
dynamically calculating a distance and a traveling direction between the mobile device and a candidate location, and guiding the distance and the traveling direction by voice;
capturing the two-dimensional barcode of the candidate location when the mobile device reaches the candidate location, and reading location information of the candidate location;
setting the candidate location as an initial location and recalculates the actual navigation route and the map data navigation route from the candidate location to the target location; and
updating and displaying the two-dimensional plan map and the map data navigation route.

7. The indoor voice navigation method of claim 6, further comprising:
guiding a place to pass through on the actual navigation route or enabling a user to voice input the target location or an identifiable sign.

8. The indoor voice navigation method of claim 6, wherein the at least one positioning location includes any one of an intersection, a curved road, an elevator entrance, or a stairway.

9. The indoor voice navigation method of claim 6, wherein the two-dimensional barcode includes a QR code.

10. The indoor voice navigation method of claim 6, wherein the distance includes a horizontal distance and a vertical distance.

11. A non-transitory computer readable medium comprising computer codes stored thereon, the computer codes when executed by one or more processors cause the one or more processors to perform an indoor voice navigation method comprising steps of:
storing a two-dimensional plan map corresponding to an indoor environment;
inputting an initial location and a target location in the indoor environment to calculate an actual navigation route from the initial location to the destination location, thereby outputting a predetermined map data navigation route corresponding to the route from the initial location to the target location on the two-dimensional plan map;
searching for one of the at least one positioning location closest to the mobile device on the map data navigation route, and automatically setting the closest one as a candidate location;
dynamically calculating a distance and a traveling direction between the mobile device and a candidate location, and guiding the distance and the traveling direction by voice;
capturing the two-dimensional barcode of the candidate location when the mobile device reaches the candidate location, and reading location information of the candidate location;
setting the candidate location as an initial location and recalculates the actual navigation route and the map data navigation route from the candidate location to the target location; and
updating and displaying the two-dimensional plan map and the map data navigation route.

12. The non-transitory computer readable medium of claim 11, further comprising:
guiding a place to pass through on the actual navigation route or enabling a user to voice input the target location or an identifiable sign.

13. The non-transitory computer readable medium of claim 11, wherein the at least one positioning location includes any one of an intersection, a curved road, an elevator entrance, or a stairway.

14. The non-transitory computer readable medium of claim 11, wherein the two-dimensional barcode includes a QR code.

15. The non-transitory computer readable medium of claim 11, wherein the distance includes a horizontal distance and a vertical distance.
